(19) United States
(12) Patent Application Publication
(10) Pub. No.: US 2008/0216638 A1
(43) Pub. Date: Sep. 11, 2008

(54) SYSTEM AND METHOD FOR IMPLEMENTING A HIGH SPEED DIGITAL MUSICAL INTERFACE

(76) Inventor: Charles H. Hustig, The Villages, FL (US)

Correspondence Address: HAYNES AND BOONE, LLP, 901 Main Street, Suite 3100, Dallas, TX, 75202, US

(21) Appl. No.: 12/042,478

(22) Filed: Mar. 5, 2008

Related U.S. Application Data
(60) Provisional application No. 60/905,160, filed on Mar. 5, 2007.

(51) Int. Cl. G10H 7/00

(52) U.S. Cl. 84/645

(57) ABSTRACT

A system for the high speed digital transmission of musical commands includes a transmitter and a receiver. The transmitter includes a MIDI input that provides key-on commands. A bitstream formatter in the transmitter maps the key-on commands to a plurality of mapped key-on commands. The transmitter also includes a synchronizing stage, a line coder, and an output driver that prepare and subsequently output the mapped key-on commands to a transmission medium. The receiver includes a signal receiver and a line decoder for receiving and decoding the commands from the transmission medium. The receiver also includes a synchronizing stage. A serial-to-parallel converter in the receiver responds to the mapped key-on commands by activating associated outputs. A driver produces an electrical output.

### CROSS REFERENCE

The present application claims the benefit of U.S. Provisional Patent Application Ser. No. 60/905,160, which is herein incorporated by reference in its entirety.

### BACKGROUND

The Musical Instrument Digital Interface (MIDI) is a 31.25 Kbps serial interface that is generally limited to connections of less than 50 feet. This low-speed format can cause significant delays when a large number of simultaneous events need to be controlled remotely.

### BRIEF DESCRIPTION OF THE DRAWINGS

The present disclosure is best understood from the following detailed description when read with the accompanying figures. It is emphasized that, in accordance with the standard practice in the industry, various features are not drawn to scale. In fact, the dimensions of the various features may be arbitrarily increased or reduced for clarity of discussion. Furthermore, all features may not be shown in all drawings for simplicity.

FIG. 1 illustrates an overview of one embodiment of a high speed digital musical interface as implemented in an instrument.

FIG. 2 illustrates a transmitter in accordance with one embodiment of a high speed digital musical interface.

FIG. 3 illustrates a receiver in accordance with one embodiment of a high speed digital musical interface.

FIG. 4 illustrates a method for integrating information from multiple sources.

### DETAILED DESCRIPTION

The present disclosure relates generally to musical interfaces and devices for transmitting and receiving musical control data. It is understood, however, that the following disclosure provides many different embodiments, or examples, for implementing different features of the invention. Specific examples of components and arrangements are described below to simplify the present disclosure. These are, of course, merely examples and are not intended to be limiting.

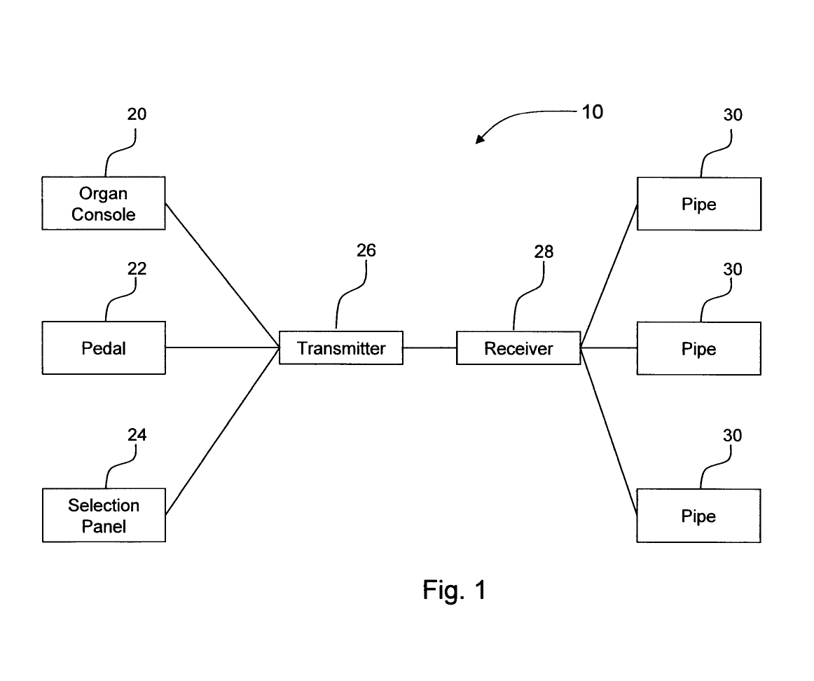

Referring to FIG. 1, illustrated is an overview of one embodiment of a high speed digital musical interface as implemented in an instrument 10. As illustrated, the instrument 10 is a pipe organ that includes an organ console 20, a pedal 22, and a selection panel 24. Other instruments with more, fewer, or different components are also possible. The organ console 20 may be any suitable organ console, such as one that provides a standard MIDI output. The pedal 22 may likewise be any suitable pedal, or a combination of multiple pedals. For instance, the pedal 22 may be a volume pedal. The output of the pedal 22 may be a standard MIDI output. In other embodiments, the pedal 22 may output another form of output, for example an analog signal whose voltage corresponds with the pedal position.

The selection panel 24 may also provide a MIDI output, or it may provide an output in another format. The selection panel 24 may include one or more switches for activating various features that affect the musical output of the instrument 10. In one embodiment, the selection panel 24 is a stop selection panel with a plurality of electronic buttons for activating stops on a pipe organ. The selection panel 24 may also provide a plurality of indicators, such as LEDs, that indicate whether or not each stop is currently activated.

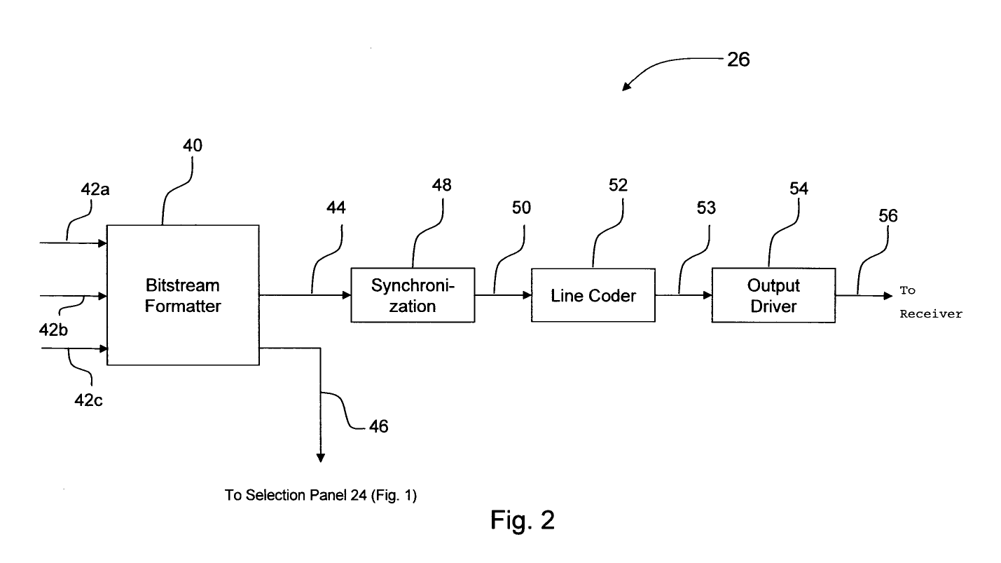

The outputs from the organ console 20, the pedal 22, and the selection panel 24 are input to a transmitter 26. As will be described in greater detail with reference to FIG. 2, the transmitter 26 processes the signals input thereto to create an output signal that is transmitted to a receiver 28. The receiver 28 uses the received signal to activate one or more instrument elements 30. In general, the instrument elements 30 may be any suitable device capable of producing sound. As illustrated, the instrument elements 30 are pipes of a pipe organ, but other instrument elements are also contemplated. For example, the instrument elements 30 may include bells of a carillon, or robotically played pianos, wind instruments, brass instruments, or string instruments, or the like. Furthermore, the instrument elements 30 may be of different types. For example, the instrument elements 30 may include bells, pipes, and synthesizers. Through the use of the selection panel 24, the musician may be able to control more ranks of pipes and combinations of ranks of pipes than the organ console 20 has available stops. For instance, the instrument 10 may have been enlarged by the addition of ranks without the replacement of the organ console 20.

Thus it is understood from FIG. 1 that a musician playing the instrument 10 may activate groups of instrument elements 30 at the selection panel 24. The groups of instrument elements 30 may be ranks of pipes (also known as stops) of a pipe organ. The musician may use the pedal 22 to indicate a volume level. Then, then musician may play music using the organ console 20, activating individual keys to play corresponding musical notes. When the musician presses a key, the organ console 20 sends a key-on command to the transmitter 26. The transmitter 26 responds to the key-on command by sending one or more key-on commands to the receiver 28, each key-on command corresponding to a stop activated at the selection panel 24. Thus, pressing one key on the organ console 20 may cause the transmitter 26 to transmit a plurality of key-on commands corresponding to the active stops.

Referring now to FIG. 2, illustrated is one embodiment of the transmitter 26. The illustrated embodiment is suitable for use in a pipe organ, although other embodiments are also contemplated. The transmitter 26 includes a bitstream formatter 40 that receives signals, designated in FIG. 2 by reference numerals 42a, 42b, and 42c, from the organ console 20, the pedal 22, and the selection panel 24 (FIG. 1). The signals 42a-42c may include MIDI command streams from the organ console 20, the pedal 22, and the selection panel 24. The signals 42a-42c may alternately include non-MIDI command streams, such as commands in a proprietary format, or other analog or digital information. In some embodiments, the transmitter 26 may receive signals from other sources, and may receive more or fewer input signals that illustrated.

The bitstream formatter 40 integrates the received signals 42a-42c to produce an output command sequence 44. To perform this integration, the bitstream formatter 40 may map key-on and key-off messages (also known as note-on and note-off messages, or key-on and key-off commands) from the organ console 20 to key-on and key-off messages for the instrument elements 30. For example, a switch setting on the selection panel 24 may indicate that key-on/off messages should map to a different one or to multiple ones of the instrument elements 30. Thus, depending on the activation of the switches on the selection panel 24, the mapping performed by the bitstream formatter 40 may cause a single key on/off message to map to a plurality of key-on/off messages.

Although the mapped messages produced by the bitstream formatter 40 are referred to as key-on and key-off messages, they may or may not have the same format as the key-on and key-off messages received from the organ console 20. In some embodiments, the mapped messages may be in a proprietary format. The mapped messages (output from the bitstream formatter 40) may also be referred to as pipe-on and pipe-off messages when they are directed to pipes in a pipe organ. In other embodiments, the bitstream formatter 40 may pass all messages received at inputs 42a-42c without performing any mapping.

The bitstream formatter 40 also integrates information from the pedal 22. For example, an organ console 20 may not provide a mechanism for adjusting the volume. Thus, the pedal 22 may be a volume pedal that provides this volume adjustment mechanism to supplement the organ console 20. The bitstream formatter 40 integrates the volume information from the pedal 22 with the key on/off messages from the organ console 20 to produce key on/off messages with volume information.

The bitstream formatter 40 provides an output 46 to indicate the state of the switches on the selection panel 24 (FIG. 1). The output 46 is connected to the selection panel 24 to provide indicators as to whether each switch on the selection panel 24 is activated. In this way, a musician may confirm that the state of the selections maintained by the bitstream formatter 40 is in agreement with the musician's desires. In other embodiments, the bitstream formatter 40 may not provide output 46. For example, the selection panel 24 may maintain its own state information, or there may be no indication of the state of the selections provided to a musician.

A command sequence 44 from the bitstream formatter 40 is provided to a synchronizer 48. The synchronizer 48 may add synchronization information to the command sequence 44 to produce a synchronized command sequence 50. The synchronization information may permit or assist the receiver 28 (FIG. 1) to remain synchronized with the transmitter 26.

A line coder 52 encodes the synchronized command sequence 50 using a suitable transmission code, including for example, bi-phase digital coding, di-phase coding, Manchester coding, DDS FSK modulation of a carrier, FM modulation of a carrier, or ASK modulation of a carrier. Other transmission coding schemes are also possible. The line coder 52 may also add a spreading code or an encryption code modulo-2. The line coder 52 outputs an encoded signal 53 to an output driver 54. The output driver 54 then outputs a transmitted signal 56 using a suitable transmission medium, such as fiber optic link, RF wireless link, coaxial cable or CAT5 cable. Other transmission media are also possible.

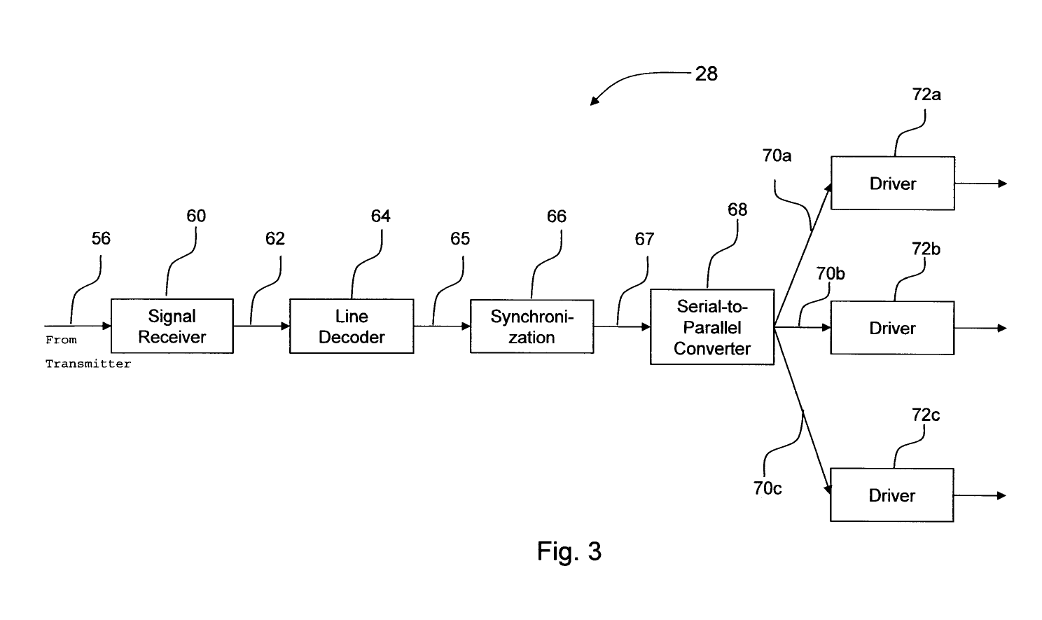

Referring now to FIG. 3, illustrated is one embodiment of the receiver 28. The receiver 28 includes a signal receiver 60 that receives the transmitted signal 56 from the transmitter 26. The signal receiver 60 may be any suitable device appropriate for the transmission medium of the transmitted signal 56. Exemplary devices that could be used as the signal receiver 60 include a photodiode, an RF receiver, and a line receiver. The signal receiver 60 provides an encoded signal 62 to a line decoder 64.

The line decoder 64 decodes the encoded signal 62 using a decode corresponding to the code previously used by the line coder 52 to encode. For example, if the line coder 52 uses FM modulation, then the line decoder 64 uses FM demodulation. The line decoder 64 outputs a decoded signal 65.

The decoded signal 65 is provided to a synchronization module 66. The synchronization module 66 interprets and removes the synchronization information previously added by the synchronizer 48. The synchronization module 66 outputs a signal 67 to a serial-to-parallel converter 68.

The serial-to-parallel converter 68 converts a sequence of serially received messages in the decoded signal 65 to a plurality of simultaneous output signals 70a-70c. Although the embodiment depicted in FIG. 3 is shown with three output signals, it is understood that other embodiments may have more or fewer output signals 70. The output signal 70a is connected to a driver 72a, which may be an open-collector driver for controlling an instrument element 30. For instance, the driver 72a may control an air valve for an organ pipe. The other output signals 70b and 70c are similarly connected to drivers 72b and 72c so that each may also control an instrument element 30. In some embodiments, the serial-to-parallel converter 68 may perform the mapping previously described above the bitstream formatter 40.

Although the embodiments shown in FIGS. 1-3 illustrate one transmitter and one receiver, it is understood that other embodiments may have multiple transmitters, multiple receivers, or both. For example, a pipe organ may have thousands of pipes, so a receiver may be installed at each rank. Thus, each receiver may have an output for controlling each pipe in its rank.

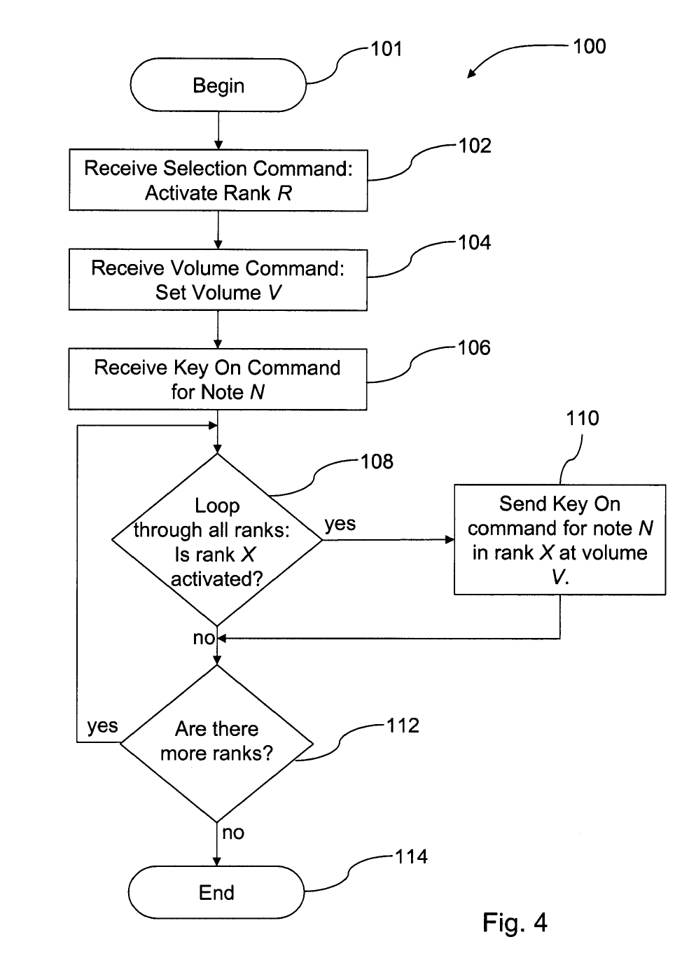

FIG. 4 illustrates a method 100 for integrating information from multiple sources, such as may be performed by the bitstream formatter 40 or the serial-to-parallel converter 68. Execution begins at step 101. At step 102, a selection command is received. The selection command indicates that a rank R is now activated. The selection command may be received from the selection panel 24, the organ console 20, or another suitable source.

Execution continues to step 104, where a volume command is received. The volume command indicates a desired volume level V. The volume command may be received from the pedal 22 or another suitable source.

In step 106, a key-on command is received for the musical note N. The key-on command may be received form the organ console 20 or another suitable source. In step 108, a determination is made whether a rank is activated. If the rank is determined to be active (for example, rank R that was activated in step 102), then execution proceeds to step 110. At step 110, a command is sent to activate the pipe for note N of rank R using volume level V. The command sent at step 110 may be formatted as a MIDI command at the byte level, or the command sent at step 110 may be in a proprietary message format, or a proprietary extension of the MIDI message format. Although the command may be formatted as a MIDI command at the byte level, as contemplated by the present disclosure the command will be sent via a high speed digital interface in lieu of a traditional MIDI serial interface.

After step 110, or if in step 108 the rank is not determined to be active, execution proceeds to step 112. In step 112, a determination is made whether there are additional ranks to be considered. If there are additional ranks, execution returns to step 108 to evaluate the next rank. If there are no more ranks to be considered, execution concludes at step 114.

Another method, similar to the method 100, may also be used to respond to key-off messages by sending a corresponding key-off message for each of the activated ranks. Alternately, a key-on message with zero volume may be used in the place of the key-off command.

In summary, a high speed digital musical interface is disclosed. A system incorporating the interface includes a transmitter and a receiver. The transmitter includes a MIDI input that provides key-on commands. A bitstream formatter in the transmitter maps the key-on commands to a plurality of mapped key-on commands. The transmitter also includes a synchronizing stage, a line coder, and an output driver that prepare and subsequently output the mapped key-on commands to a transmission medium. The receiver includes a signal receiver and a line decoder for receiving and decoding the commands from the transmission medium. The receiver also includes a synchronizing stage. A serial-to-parallel converter in the receiver responds to the mapped key-on commands by activating associated outputs. A driver produces an electrical output.

The present disclosure has been described relative to a preferred embodiment. Improvements or modifications that become apparent to persons of ordinary skill in the art only after reading this disclosure are deemed within the spirit and scope of the application. It is understood that several modifications, changes and substitutions are intended in the foregoing disclosure and in some instances some features of the invention will be employed without a corresponding use of other features. Accordingly, it is appropriate that the appended claims be construed broadly and in a manner consistent with the scope of the invention.

What is claimed is:

1. A system for implementing a high speed digital musical interface, the system comprising:
a musical control data transmitter configured to receive a key-on command that specifies a musical note, the transmitter comprising:
a bitstream formatter configured to map the key-on command to a plurality of mapped key-on commands;
a synchronizing stage configured to add synchronization information to the plurality of mapped key-on commands to produce a synchronized plurality of mapped key-on commands; and
a line coder configured to encode the synchronized plurality of mapped key-on commands to produce an encoded synchronized plurality of mapped key-on commands; and
a musical control data receiver configured to receive the encoded synchronized plurality of mapped key-on commands from the transmitter via a transmission medium, the receiver further comprising:
a line decoder configured to decode the encoded synchronized plurality of mapped key-on commands to recover the synchronized plurality of mapped key-on commands;
a synchronizing stage configured to remove and interpret the synchronization information from the synchronized plurality of mapped key-on commands to recover the plurality of mapped key-on commands; and
a serial-to-parallel converter that responds to the plurality of mapped key-on commands by activating a converted output that is associated with one of the plurality of mapped key-on commands.

2. The system of claim 1 wherein the musical control data transmitter further comprises an input coupled to a pedal that provides a volume information, and wherein the bitstream formatter incorporates the volume information into the mapped key-on commands.

3. The system of claim 1 wherein the musical control data transmitter further comprises a selection input coupled to a selection panel comprising a plurality of switches and associated indicators, the selection panel providing a selection information to the musical control data transmitter at the selection input, and wherein the bitstream formatter incorporates the selection information into the mapped key-on commands.

4. The system of claim 3 wherein the musical control data transmitter further comprises a status output signal coupled to the selection panel for providing selection state information to the associated indicators of the selection panel.

5. The system of claim 1 wherein the transmission medium is a fiber optic link.

6. The system of claim 1 wherein the transmission medium is an RF wireless link.

7. The system of claim 1 further comprising a plurality of musical control data receivers and wherein each of the plurality of musical control data receivers is associated with a rank of a pipe organ.

8. The system of claim 7 wherein the musical control data transmitter is configured to receive the key-on command from an organ console.

9. The system of claim 1 wherein a distance between the musical control data transmitter and the musical control data receiver is at least 50 feet.

10. A method for implementing a high speed digital musical interface, the method comprising:
receiving a selection command to activate a selected rank;
receiving a volume command to set a specified volume;
receiving a first key-on command to produce a specified note;
determining which ones of a plurality of available ranks are activated; and
for each available rank that is activated, sending a second key-on command to produce the specified note in the activated rank at the specified volume.

11. The method of claim 10 further comprising:
receiving a first key-off command to cease the production of the specified note;
determining which ones of the available ranks are activated; and
for each available rank that is activated, sending a second key-off command to cease the production of specified note in the activated rank.

12. The method of claim 10 further comprising:
receiving the second key-on command at a remote location associated with the selected rank; and
opening an air valve associated with a pipe to produce the specified note at the specified volume.

13. The method of claim 10 further comprising receiving a selection command to activate a second selected rank.

14. The method of claim 10 wherein the first key-on command is received on a standard MIDI input.

15. The method of claim 14 wherein the second key-on command is sent through a high-speed digital interface.

16. A system for implementing a high speed digital musical interface, the system comprising:
means for receiving a selection command to activate a selected rank;
means for receiving a volume command to set a specified volume;
means for receiving a first key-on command to produce a specified note;
means for determining which ones of a plurality of available ranks are activated; and
means for sending a second key-on command to produce the specified note in each available rank that is activated at the specified volume.

17. The system of claim 16 further comprising:
means for receiving a first key-off command to cease the production of the specified note;
means for determining which ones of the available ranks are activated; and
means for sending a second key-off command to cease the production of specified note in each available rank that is activated.

18. The system of claim 16 further comprising:
means for receiving the second key-on command at a remote location associated with the selected rank; and
means for opening an air valve associated with a pipe to produce the specified note at the specified volume.

19. The system of claim 16 further comprising means for receiving a selection command to activate a second selected rank.

20. The system of claim 16 wherein the first key-on command is received on a standard MIDI input.
